(19) United States
(12) Patent Application Publication
(10) Pub. No.: US 2016/0219854 A1
(43) Pub. Date: Aug. 4, 2016

(54) Fishing Line Entanglement Prevention Device

(71) Applicant: Michael Ray Schultz, Marinette, WI (US)

(72) Inventor: Michael Ray Schultz, Marinette, WI (US)

(21) Appl. No.: 15/002,529

(22) Filed: Jan. 21, 2016

Related U.S. Application Data
(60) Provisional application No. 62/109,145, filed on Jan. 29, 2015.

(51) Int. Cl. A01K 91/053

(52) U.S. Cl. CPC A01K 91/053

(57) ABSTRACT

A fishing line entanglement prevention device for preventing entanglement of weight line and bait lines includes a splitting member having a tubular vertical arm defining a vertical arm channel and a tubular lateral arm defining a lateral arm channel. The lateral arm channel is in communication with the vertical arm channel. A weight line bracing member includes an arm portion having a top end coupled to the splitting member and a bottom end, the arm portion defining an opening adjacent the bottom that is capable of receiving the bait line. The weight line bracing member is configured for selective insertion into the lateral arm channel. The bottom end of the arm portion of the bracing member defines a slot capable of engaging the weight line when the bracing member is inserted into the lateral arm channel.

### REFERENCE TO RELATED APPLICATIONS

This application claims the benefit of provisional patent application U.S. Ser. No. 62/109,145 filed 29 Jan. 2015 titled “Fishing Line Entanglement Prevention Device” which is incorporated herein by reference.

### FIELD OF THE INVENTION

The present invention relates to a device for preventing entanglement of two lines used in fishing: a line used for carrying a weight and a line carrying bait with hooks for catching the fish.

### BACKGROUND OF THE INVENTION

The fishing line connected to a fishing pole typically includes hooks configured to receive bait thereon. While strong, the line is thin. The line also needs to have a weight extension that insures that the bait sinks to the desired depth where the fish are located. The weight extension and the bait often become entangled which can diminish the exposure of the bait and keep the fish away.

Various configurations of lines, weights, and hooks are known in the art of fishing. Although presumably effective for their intended purposes, the existing devices and prior patents proposed complicated combinations of fishing line hook and weight combinations that do not effectively present entanglement of a fishing line in use with a weight, hooks, and bait/lure.

It would be therefore desirable to provide a fishing line entanglement prevention device that maintains a separation between the weight line and the bait line so as to prevent entanglement and may be set to maintain the desired depth for the baits.

### SUMMARY OF THE INVENTION

A fishing line entanglement prevention device for preventing entanglement of a weight line and bait line used in fishing according to the present invention includes a splitting member that includes a vertical arm defining a vertical arm channel traversing between opposed open top and bottom ends and a lateral arm defining a lateral arm channel traversing through a length of the lateral arm between opposed first and second open ends. The lateral arm channel is in communication with the vertical arm channel proximate the first open end of the lateral arm. A weight line bracing member includes an arm portion having a top end selectively coupled to the splitting member and a bottom end, the arm portion defining an opening adjacent the bottom that is capable of receiving the bait line therethrough.

The weight line bracing member is configured for selective insertion into the lateral arm channel such that the top end is adjacent to the vertical arm of the splitting member when inserted therein. The bottom end of the arm portion of the bracing member defines a slot having a configuration capable of engaging the weight line when the bracing member is inserted into the lateral arm channel.

Therefore, a general object of the present invention is to provide a fishing line entanglement prevention device that maintains a separation between the weight line and the bait line so as to prevent entanglement and may be set to maintain the desired depth for the baits.

### BRIEF DESCRIPTION OF THE DRAWINGS

FIG. 1 is a perspective view of a fishing line entanglement prevention device according to a preferred embodiment of the present invention;

FIG. 2 is another perspective view of the entanglement prevention device as in FIG. 1 removed from the fishing lines and bait;

FIG. 3 is an exploded view of the entanglement prevention device as in FIG. 2;

FIG. 4 is another perspective view of the entanglement prevention device as in FIG. 2;

FIG. 5a is a top view of the entanglement prevention device as in FIG. 4;

FIG. 5b is a sectional view taken along line 5b-5b of FIG. 5a, illustrated with the weight line bracing member exploded from the lateral arm; and

FIG. 5c is a sectional view taken along line 5b-5b of FIG. 5a, illustrated with the weight line bracing member inserted into the lateral arm.

### DETAILED DESCRIPTION OF THE INVENTION

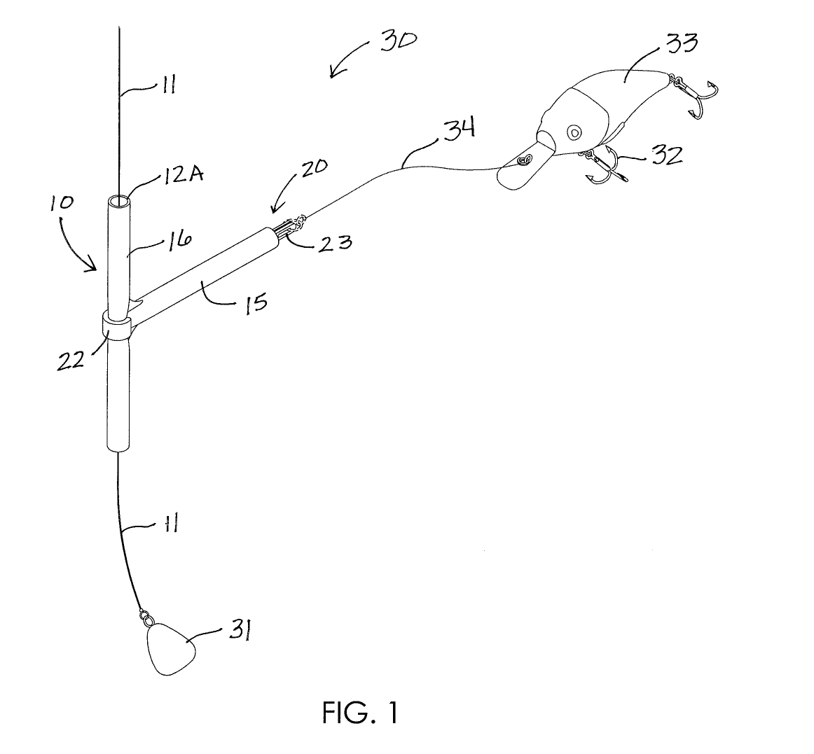

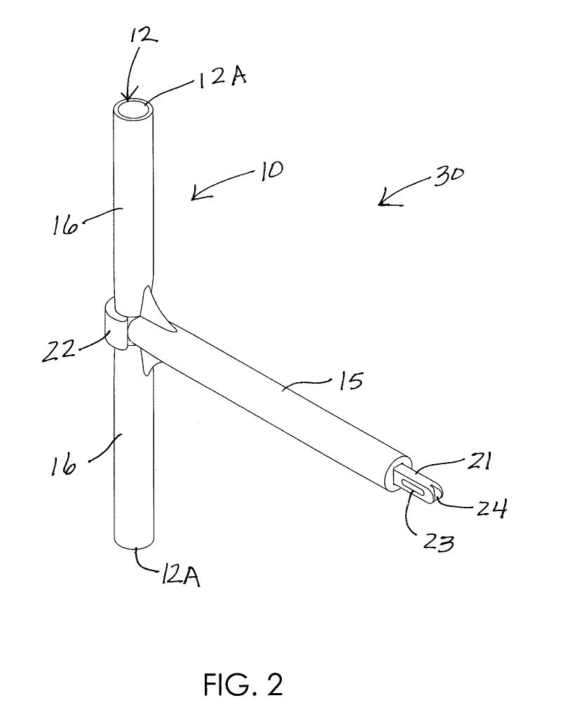

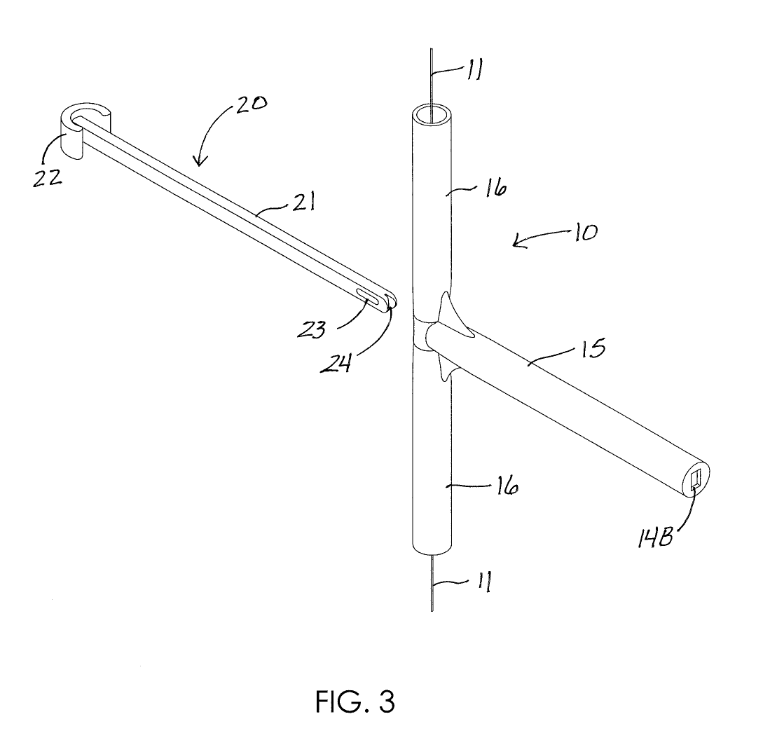

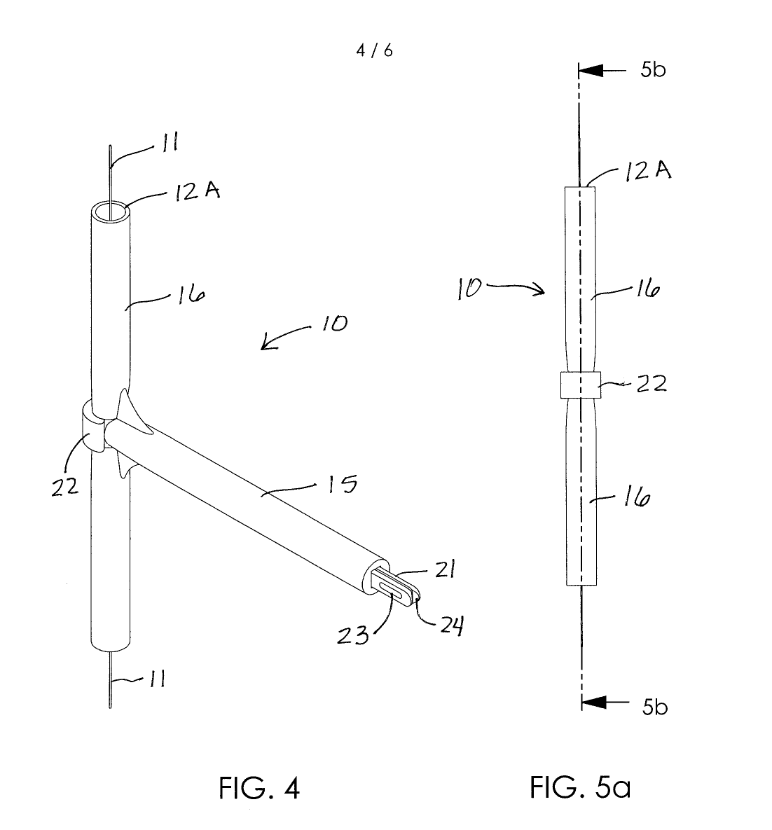

A fishing line entanglement prevention device according to a preferred embodiment of the present invention will now be described with reference to FIGS. 1 to 5c of the accompanying drawings. The fishing line entanglement prevention device 30 includes a splitting member 10 and a weight line bracing member 20.

The splitting member 10 has a vertical arm 16 having a tubular shape that defines a vertical arm channel 12 that traverses through the length of the vertical arm 16. The vertical arm 16 defines opposed top and bottom open ends 12A in communication with the vertical arm channel 12. A lateral arm 15 having a substantially tubular shape is connected to the vertical arm 16 at about a mid-point of the vertical arm 16. The lateral arm 15 may be perpendicular to the vertical arm 16. The lateral arm defines a rectangular lateral arm channel 14 and defines an opening 14B at a rear side of the splitting member 10 and a rectangular opening 14A in the front side of the vertical arm 16. The openings are in communication with the lateral arm channel 14 and are configured to enable a weight line 11 to enter and exit therethrough, respectively, as will be described in more detail later.

The long side of the rectangular opening 14A is parallel with the length of the vertical arm 16. Again, the vertical arm channel 12 is in communication with the lateral arm channel 14 adjacent opening 14A. It is noted that other shapes for the vertical and lateral arms, such as square, rectangular and triangular also fall within the scope of the present invention.

The weight line bracing member 20 includes an elongate arm portion 21 having a top end and a bottom end. The arm portion 21 may have a rectangular configuration complementary to the rectangular lateral arm channel 14 such that the arm portion 21 may be selectively inserted into the lateral arm channel 14. It is understood that the rectangular configurations prevent rotational movement of the bracing member 20 relative to the lateral arm 15. The top end of the arm portion 21 may be in the form of a fastener 22, such as a clamp, configured to selectively engage the vertical arm 16 of the splitting member 10.

The bottom end of the weight line bracing member 20 may define a slot 24. The first side width W1 of the arm portion 21 corresponds to the length of the rectangular opening 14A while the second side width W2 matches the width of the rectangular opening 14A. The openings 14A and 14B are configured to receive the arm portion 21 into the lateral arm channel 14 defined by the lateral arm 10 of the splitting member 10.

The weight line 11 may be a generally thin but strong wire to which a weight 31 may be attached. The weight line 11 may be threaded through the top opening of the vertical arm 16 and exiting through the bottom opening of the vertical arm 16 so that the weight line 11 passes through the vertical arm channel 12. The weight 31 may be attached to the end of the weight line 11 exiting through the bottom end of the vertical arm 16. The weight line 11 that enters the vertical arm 16 originates from and is attached to a fishing pole, e.g. a reel.

The first side of the weight line bracing member 20 defines an opening 23 adjacent the bottom end of the arm portion 21. The opening 23 will enable a bait line 34 to be attached to the arm portion 21 of the weight line bracing member 20, as will be described in more detail later. In addition, the bottom end of the arm portion 21 of the weight line bracing member 20 defines a slot 24 or notch configured to engage the weight line 11 when the bracing member 20 is inserted into the lateral arm channel 14.

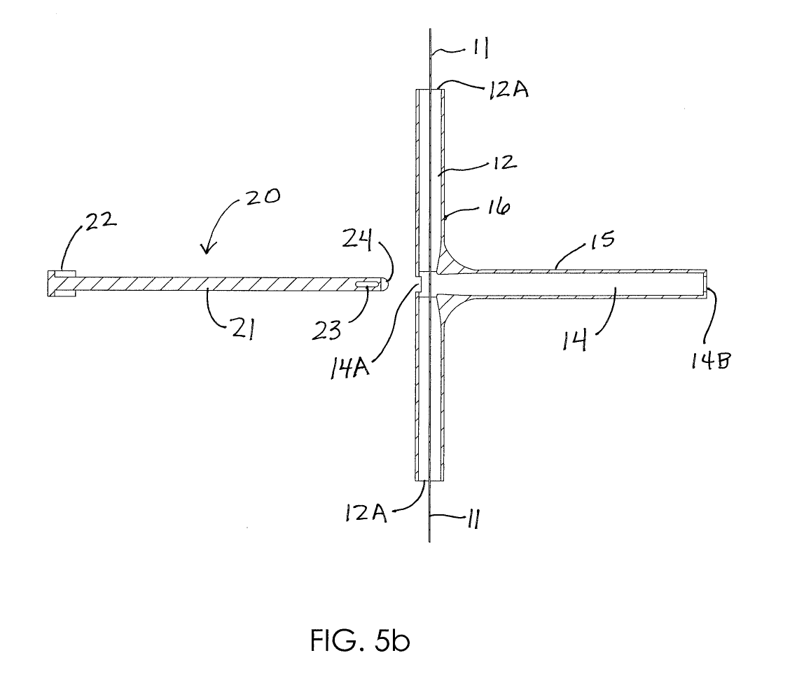

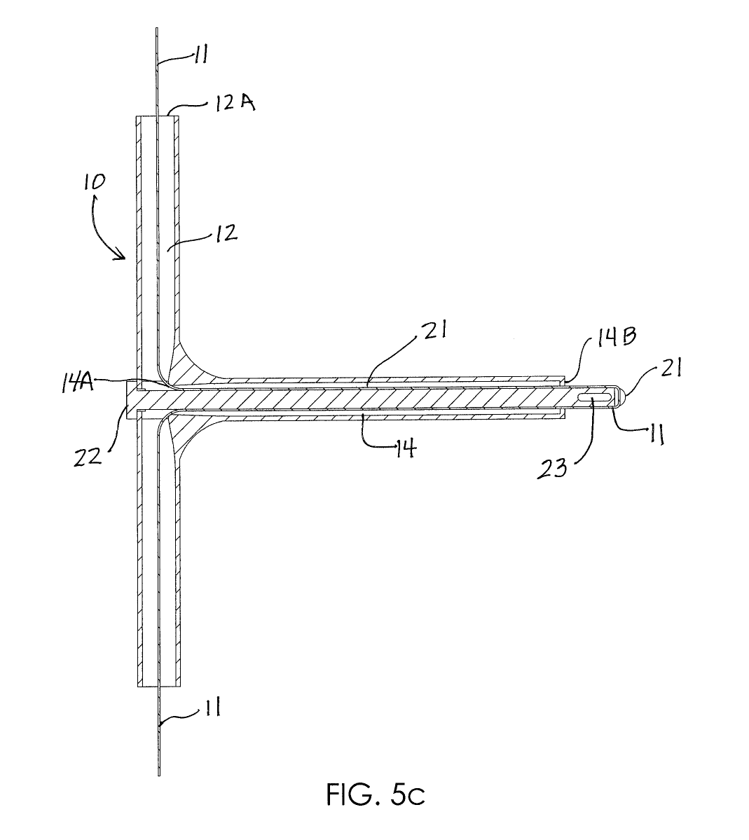

The weight line bracing member 20 is configured for selective inserted through rectangular opening 14A in the front side of the vertical arm 16 and into the lateral arm channel. The insertion causes the slot 24 to catch or engage the weight line 11 and push it through the lateral arm channel 14 (i.e. the lateral arm channel) and out of the opening 14B of lateral arm 15. FIGS. 5b and 5c illustrate the position of the weight line 11 before and after insertion of the weight line bracing member 20. This insertion has the effect of bracing the weight line 11. This setup has the benefit of locking or predetermining the depth at which the device 30 will be positioned in a body of water, e.g. while fishing.

In use, the length of the weight line 11 is set to the desired depth where the fish are roaming. Next, the weight line bracing member 20 may be inserted through rectangular opening 14A in the front side of the vertical arm 16 of the splitting member 10 all the way through the lateral arm channel 14 to the bottom end. As described above, this insertion causes the weight line 11 to be captured by the slot 24 and the weight line 11 is secured. This locks this depth and prevents up or down movement of the device 30 once positioned in a body of water, such as while fishing. The fastener 22 couples the weight line bracing member 20 to the splitting member 10 to ensure the integrity of the device 30 in use.

A bait line 34 to which the bait 33 and hooks 32 are attached may be coupled to the weight line bracing member 20 so as to provide bait for fishing. More particularly, the bait line 34 may be attached to the opening 23 that is at the end of the arm portion 21 of the weight line bracing member 20, such as by inserting an end of the bait line 34 through the opening 23 and tying a knot.

Accordingly, the assembled device is configured to keep the bait 33 and the weight 31 separate and prevent them from entangling. This configuration also uses less wire than in a conventional fishing pole setup.

It should be understood, of course, that the foregoing relates to exemplary embodiments of the invention and that modifications may be made without departing from the spirit and scope of the invention.

1. A fishing line entanglement prevention device for preventing entanglement of a weight line and bait line used in fishing, said device comprising:
a splitting member that includes a vertical arm defining a vertical arm channel traversing between opposed open top and bottom ends and a lateral arm defining a lateral arm channel traversing through a length of the lateral arm between opposed first and second open ends;
wherein said lateral arm channel is in communication with said vertical arm channel proximate said first open end of said lateral arm;
a weight line bracing member that includes an elongate arm portion having a top end selectively coupled to said splitting member and a bottom end capable of communicating with the bait line;
wherein said arm portion of said weight line bracing member is configured for selective insertion into said lateral arm channel so that said top end is adjacent to said vertical arm of said splitting member at said first open end of said lateral arm and said bottom end of said arm portion protrudes from said second end of said lateral arm.

2. The entanglement prevention device as in claim 1, wherein said vertical arm has a tubular configuration and said vertical arm channel has a tubular configuration configured to selectively receive the weight line therein.

3. The entanglement prevention device as in claim 1, wherein:
said arm portion of said weight line bracing member includes a rectangular configuration;
said lateral arm channel has a rectangular configuration configured to selectively receive said arm portion therein in a non-rotatable friction relationship.

4. The entanglement prevention device as in claim 1, wherein said lateral arm is generally perpendicular to said vertical arm such that said entanglement prevention device includes a generally T-shaped configuration.

5. The entanglement prevention device as in claim 1, wherein said arm portion includes a fastener coupled to said top end, said fastener being configured to selectively attach to said vertical arm when said bracing member is inserted in said lateral arm channel.

6. The entanglement prevention device as in claim 5, wherein said fastener is a clamp configured to couple said bracing member to said vertical arm in a friction fit arrangement.

7. The entanglement prevention device as in claim 1, wherein said arm portion of said bracing member defines an opening adjacent said bottom end that is configured to receive the bait line therethrough.

8. The entanglement prevention device as in claim 1, wherein:
said vertical arm channel is configured to receive the weight line;
said bottom end of said arm portion of said bracing member extends away from said open end of said lateral arm when said arm portion is inserted in said lateral arm channel.

9. The entanglement prevention device as in claim 8, wherein said bottom end of said arm portion of said bracing member defines a slot having a configuration capable of engaging the weight line when said bracing member is inserted into said lateral arm channel.

10. The entanglement prevention device as in claim 1, wherein said bottom end of said arm portion of said bracing member defines a slot having a configuration capable of engaging the weight line when said bracing member is inserted into said lateral arm channel.

11. A fishing line entanglement prevention device for preventing entanglement of
a weight line and bait line used in fishing, said device comprising:
a splitting member that includes a vertical arm defining a vertical arm channel traversing between opposed open top and bottom ends and a lateral arm defining a lateral arm channel traversing through a length of the lateral arm between opposed first and second open ends;
wherein said lateral arm channel is in communication with said vertical arm channel proximate said first open end of said lateral arm;
a weight line bracing member that includes an arm portion having a top end selectively coupled to said splitting member and a bottom end, said arm portion defining an opening adjacent said bottom that is capable of receiving the bait line therethrough;
wherein said arm portion of said weight line bracing member is configured for selective insertion into said lateral arm channel such that said top end is adjacent to said vertical arm of said splitting member when inserted therein;
wherein said bottom end of said arm portion of said bracing member defines a slot having a configuration capable of engaging the weight line when said bracing member is inserted into said lateral arm channel.

12. The entanglement prevention device as in claim 11, wherein said vertical arm has a tubular configuration and said vertical arm channel has a tubular configuration configured to selectively receive the weight line therein.

13. The entanglement prevention device as in claim 11, wherein:
said arm portion of said weight line bracing member includes a rectangular configuration;
said lateral arm channel has a rectangular configuration configured to selectively receive said arm portion therein in a non-rotatable friction relationship.

14. The entanglement prevention device as in claim 11, wherein said lateral arm is generally perpendicular to said vertical arm such that said entanglement prevention device includes a generally T-shaped configuration.

15. The entanglement prevention device as in claim 11, wherein said arm portion includes a fastener coupled to said top end, said fastener being configured to selectively attach to said vertical arm when said bracing member is inserted in said lateral arm channel.

16. The entanglement prevention device as in claim 15, wherein said fastener is a clamp configured to couple said bracing member to said vertical arm in a friction fit arrangement.

17. The entanglement prevention device as in claim 11, wherein:
said arm portion of said weight line bracing member includes a rectangular configuration;
said lateral arm channel has a rectangular configuration configured to selectively receive said arm portion therein in a non-rotatable friction relationship;
said arm portion includes a fastener coupled to said top end, said fastener being configured to selectively attach to said vertical arm when said bracing member is inserted in said lateral arm channel; and
said fastener is a clamp configured to couple said bracing member to said vertical arm in a friction fit arrangement.
